(19) United States
(12) Patent Application Publication
(10) Pub. No.: US 2025/0330941 A1
(43) Pub. Date: Oct. 23, 2025

(54) UE LOCATION DETERMINATION IN A MOBILE IAB SYSTEM

(71) Applicant: Nokia Solutions and Networks Oy, Espoo (FI)

(72) Inventors: XIANG XU, Nanjing (CN); SEAN KELLEY, Hoffman Estates, IL (US); ALESSIO CASATI

(21) Appl. No.: 18/866,945

(22) PCT Filed: May 20, 2022
(86) PCT No.: PCT/CN2022/094155

§ 371 Date: Nov. 18, 2024

(51) Int. Cl. H04W 64/00; H04W 8/08; H04W 88/08

(52) U.S. Cl. CPC H04W 64/00; H04W 8/08; H04W 88/08

(57) ABSTRACT

Example embodiments relate to methods, devices, apparatuses and computer readable storage media for user equipment (UE) location determination in a mobile Integrated Access and Backhaul (IAB) system. A first device receives, from a second device in the radio access network, a first request for information associated with a transmission-reception point associated with the first device. The second device receives from a third device a second request for information associated with the transmission-reception point associated with the first device, and as a response, transmits the first request to the first device. The first device obtains a location of the transmission-reception point and corresponding mobility information. The first device transmits, to the second device, information indicative of the location of the transmission-reception point and/or the corresponding mobility information. The second device transmits, to the third device, the information indicative of the location of the transmission-reception point and/or the corresponding mobility information.

### FIELD

Example embodiments of the present disclosure generally relate to the field of communications, and in particular, to a methods, devices, apparatuses and computer readable storage media for user equipment (UE) location determination in a mobile Integrated Access and Backhaul (IAB) system.

### BACKGROUND

IAB enables wireless relaying for New Radio (NR) access by using NR for backhauling. A relay node in the LAB architecture may be referred to as IAB, IAB device or IAB-node, which provides both access and backhaul by using a NR radio access. A network node terminating the wireless backhauling on the network side may be referred to as donor, donor device or donor node, which usually is a NR Next Generation NodeB (gNB) with added functionalities to support IAB.

The positioning of user equipment (UE) can be supported by radio access technology (RAT) dependent position methods, which rely on for example RAT measurements obtained by a target UE and/or on measurements obtained by a network device. Positioning of a UE can also be supported by RAT independent position methods which may rely on non-RAT measurements obtained by a UE and/or on other information. In a fifth generation (5G) system (5GS), location services (LCS) for a UE may be supported by a location management function (LMF).

In the mobile IAB system, a vehicle mounted relay (VMR) uses 5G network utilizing moving relays (IAB-nodes) mounted in a vehicle (such as, a train, bus, tram, subway) and serving UEs either within the vehicle or in the surrounding. However, as the devices in the mobile IAB system are mobile, it is difficult to implement location determination. Therefore, among others open issues, how to efficiently and accurately determine UE location is an open issue to be addressed.

### SUMMARY

In general, example embodiments of the present disclosure provide methods, devices, apparatuses and computer readable storage media for UE location determination in an IAB system.

In a first aspect, a method is provided. In the method, a first device receives, from a second device in the radio access network, a first request for information associated with a transmission-reception point (TRP) associated with the first device. Further, the first device obtains a location of the transmission-reception point and corresponding mobility information. Then, the first device transmits, to the second device, information indicative of the location of the transmission-reception point and/or the corresponding mobility information.

In a second aspect, a method is provided. In the method, a second device transmits, to a first device in the radio access network, a first request for information associated with a transmission-reception point associated with the first device. Further, the second device receives, from the first device, information indicative of location of the transmission-reception point and/or corresponding mobility information. Then, the second device transmits, to a third device, the information indicative of the location of the transmission-reception point and/or the corresponding mobility information.

In a third aspect, a method is provided. In the method, a third device transmits, to a second device in a radio access network, a second request for information associated with a transmission-reception point associated with a first device in the radio access network. Then, the third device receives from the second device, information indicative of location of the transmission-reception point and/or corresponding mobility information.

In a fourth aspect, a first device is provided which comprises at least one processor and at least one memory including computer program code. The at least one memory and the computer program code are configured to, with the at least one processor, cause the first device to receive, from a second device in the radio access network, a first request for information associated with a transmission-reception point associated with the first device. Further, the first device is caused to obtain a location of the transmission-reception point and corresponding mobility information. Then, the first device is caused to transmit, to the second device, information indicative of the location of the transmission-reception point and/or the corresponding mobility information.

In a fifth aspect, a second device is provided which comprises at least one processor and at least one memory including computer program code. The at least one memory and the computer program code are configured to, with the at least one processor, cause the second device to transmit, to a first device in the radio access network, a first request for information associated with a transmission-reception point associated with the first device. Further, the second device is caused to receive, from the first device, information indicative of location of the transmission-reception point and/or corresponding mobility information. Then, the second device is caused to transmit, to a third device, the information indicative of the location of the transmission-reception point and/or the corresponding mobility information.

In a sixth aspect, a third device is provided which comprises at least one processor and at least one memory including computer program code. The at least one memory and the computer program code are configured to, with the at least one processor, cause the third device to transmit, to a second device in a radio access network, a second request for information associated with a transmission-reception point associated with a first device in the radio access network. Then, the third device is caused to receive from the second device, information indicative of location of the transmission-reception point and/or corresponding mobility information.

In a seventh aspect, there is provided an apparatus comprising means for performing the method according to the first or second aspect or third aspect.

In an eighth aspect, there is provided a computer readable storage medium comprising program instructions stored thereon. The instructions, when executed by a processor of a device, cause the device to perform the method according to the first or second aspect or third aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow among the first device, the second device and the third device according to some example embodiments of the present disclosure;

FIG. 3 illustrates an example process for determining UE location according to some example embodiments of the present disclosure;

FIG. 4 illustrates an example process for determining UE location according to some other example embodiments of the present disclosure;

FIG. 5 illustrates a flowchart of an example method according to some example embodiments of the present disclosure;

FIG. 6 illustrates a flowchart of an example method according to some other example embodiments of the present disclosure;

FIG. 7 illustrates a flowchart of an example method according to some further example embodiments of the present disclosure; and

FIG. 8 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

As used herein, in some example embodiments, the term “core network device” refers to a device capable of communicating with the access network device and providing services to the terminal device in a core network. Examples of the core network device may include user plane functions (UPFs), application servers, Mobile Switching Centers (MSCs), MMEs, Operation and Management (O&M) nodes, Operation Support System (OSS) nodes, Self-Organization Network (SON) nodes, positioning nodes such as Enhanced Serving Mobile Location Centers (E-SMLCs), Mobile Data Terminals (MDTs), a Common Control Network Function (CCNF), an Access and mobility Management Function (AMF), a Session Management Function (SMF), a Policy Control Function (PCF), a Location Management Function (LMF).

As used herein, the term “terminal device”, “user device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As discussed above, there are some discussions for the 5GS to support location services for the UEs accessing the 5GS via the VMR. However, when the VMR is present, the location of the cell/IAB-node serving the UEs may change, and this may affect not only positioning procedures but also regulatory services needing UE location.

Typically, for a UE connected with a VMR cell, the UE position procedure may use the TRP(s) from the VMR only. For a UE connected with a VMR cell, the UE position procedure may use the TRP(s) from the VMR and TRP(s) from a normal gNB cell. For a UE connected with a normal gNB cell, the UE position procedure may use the TRP(s) from the VMR and TRP(s) from the normal gNB cell.

In the 5GS, LCS for a UE may be supported by a LMF. The LMF determines the UE location based on the collected measurement report from the UE/TRP, and the location of the TRPs involved in the measurement. In a normal terrestrial network, the position of the TRP is fixed and known to the LMF for example by OAM configuration, or by New Radio Positioning Protocol Annex (NRPPa)/F1 Application Protocol (F1AP) signaling using the TRP information exchange procedure. However, the position of the TRP installed on a mobile vehicle may dynamically change, for example when the vehicle moves. Besides, in this case, in some scenarios for example where VMR is installed on a bus, the TRP and IAB-mobile terminal (MT)/distributed unit (DU) can be considered collocated. In some other scenarios for example where VMR is installed on a train or a ship, the TRP and IAB-MT/DU may not be collocated. For example, the IAB-MT/DU may be installed in the middle of train or the ship, while the TRPs may be deployed close to the head and tail of the train or the ship. Then, the location of the TRPs may be different to the location of the IAB-MT/DU.

By now, there is no effective way to determine the UE location in the mobile IAB system.

Example embodiments of the present disclosure provide a scheme of UE location determination in an IAB system. With the scheme, a first device receives, from a second device in the radio access network, a first request for information associated with a TRP associated with the first device. For example, the second device receives from a third device a second request for information associated with the TRP associated with the first device, and as a response, transmits the first request to the first device. Then, the first device obtains a location of the TRP and corresponding mobility information. Further, the first device transmits, to the second device, information indicative of the location of the TRP and/or the corresponding mobility information. And then, the second device transmits, to the third device, the information indicative of the location of the TRP and/or the corresponding mobility information.

This scheme facilitates flexible and accurate UE location determination by flexibly and efficiently determining the location of the TRP while considering the mobility state. As such, it is allowed to improve communication efficiency.

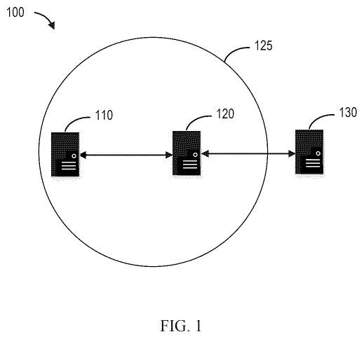

FIG. 1 shows an example environment 100 in which example embodiments of the present disclosure can be implemented.

As shown, the environment 100, which is a part of a communication network, includes devices 110, 120 in a radio access network 125 and device 130. As an example, the device 120 may communicate with the devices 110 and 130 or with other devices via the devices 110 and 130. The communication among the devices 110, 120 and 130 may be direct or indirect.

The devices 110, 120 and 130 may be implemented by any suitable devices in the communication network. In some example embodiments, some of the devices 110, 120 and 130 may be implemented by one or more terminal devices and the others may be implemented by one or more network devices, or vice versa. In some other example embodiments, the devices 110, 120 and 130 may be all implemented by terminal devices or network devices.

According to some embodiments of the present disclosure, in the environment 100, the devices 110, 120 and 130 may be implemented by network devices. Just for the purpose of discussion, in some example embodiments, the device 110 will be taken as an example of a DU of an integrated access and backhaul device (IAB-DU). The device 120 will be taken as an example of a CU of a donor device (donor-CU or IAB-donor-CU). The device 130 will be taken as an example of a location management function.

It is to be understood that the devices or functions are shown in the environment 100 only for the purpose of illustration, without suggesting any limitation. The environment 100 may include any other suitable devices, elements or functions. For example, the environment 100 may further include a further device, such as, a UE to communicate with the device 110.

The communication between the individual devices or functions in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies. The scope of the present disclosure will not be limited in this regard.

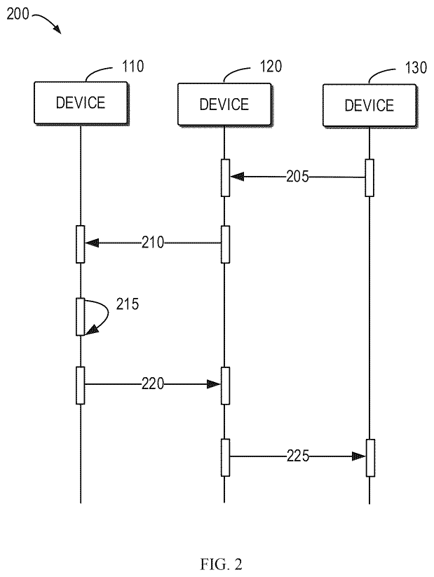

Detailed processes for UE location determination in a mobile IAB system will be discussed in the following with reference to FIGS. 2-7.

FIG. 2 shows a signaling flow 200 among the first device, the second device and the third device according to some example embodiments of the present disclosure. For the purpose of discussion, the signaling flow 200 will be described with reference to FIG. 1.

As shown in FIG. 2, the device 130 transmits (205) to the device 120 in the radio access network 125 a request (also referred to as a second request) for information associated with a TRP associated with the device 110 in the radio access network 125. In some example embodiments, the location of the TRP may be determined at the device 110. In this case, for example, the device 130 may determine a need to update the location of the TRP, if updated corresponding mobility information indicates that the TRP is mobile. Then, in response to the need to update the location of the TRP, the device 130 may transmit, to the second device 120, the second request for the information associated with the TRP. As an example, if the device 130 previously received mobility information indication that the TRP is “mobile”, then device 130 may determine the TRP's geo-coordinate need to be refreshed. If the device 130 did not previously receive mobility information indication that the TRP is “mobile”, or the device 130 previously received mobility information indication that the TRP is “not mobile”, then device 130 may assume the TRP's geo-coordinate is static and do not need to be refreshed.

Then, the device 120 transmits (210), to the device 110, a request (also referred to as a first request) for the information associated with the TRP associated with the device 110. Then, the device 110 obtains (215) a location of the TRP and corresponding mobility information.

In some example embodiments, the corresponding mobility information may indicate that the TRP is mobile. In this case, the corresponding mobility information may be a static characteristic of the IAB-node. In some other embodiments, the corresponding mobility information may indicate whether the TRP is mobile during a time period. In some other embodiments, the corresponding mobility information may indicate whether the TRP is not mobile during a time period. In this case, the corresponding mobility information may be a dynamic state of the IAB-node. For example, the TRP may be “parked” or “moving”. When the TRP is “parked”, there is no need to perform more resource/signaling intensive procedures to continually locate the TRP.

In the example embodiments where the location of the TRP is determined at the device 110, the location of the TRP may comprise a geo-coordinated position of the TRP. For example, the geo-coordinated position of the TRP may be geographical coordinates of the TRP. In this case, the device 110 may obtain the location of the TRP in variety of ways. For example, the device 110 may first obtain a position of a reference point, such as a mobile terminal device (MT) co-located with the device 110. For example, the device 110 may determine the position of the MT using global navigational satellite systems (GNSS) or by the MT triggering a mobile originated location request (MO-LR) procedure. Then, the device 110 may determine the geo-coordinated position of the TRP at least based on the position of the reference point. Further, to determine the geo-coordinated position of the TRP, it is needed to determine the relative location of the TRP with respect to the position of the reference point. For example, the device 110 may be configured with the relative location of the TRP with respect to the position of the reference point. Alternatively, the relative location of the TRP with respect to the position of the reference point may be determined based on other mechanism, for example, sidelink positioning. Then, the device 110 may determine the geo-coordinated position of the TRP based on the position of the reference point and the relative location of the TRP with respect to the position of the reference point.

In this case, for example, an information element contains the geo-coordinated position of the TRP and the corresponding mobility information may be shown in Table 1.

TABLE 1
Geographical Coordinates

| | | | | | | |
|---|---|---|---|---|---|---|
| | | | IE Type and | Semantics | | Assigned |
| IE/Group Name | Presence | Range | Reference | Description | Criticality | Criticality |

| | | | | | |
|---|---|---|---|---|---|
| CHOICE TRP Position | M | | | — | |
| Definition Type | | | | | |
| >Direct | | | | | |
| >>CHOICE Accuracy | M | | | | |
| >>>normal accuracy | | | | | |
| >>>>TRP Position | M | NG-RAN | The configured | | |
| | | Access Point | estimated | | |
| | | Position | geographical | | |
| | | 9.2.10 | position of the | | |
| | | | antenna of the | | |
| | | | cell/TRP. | | |
| >>>high accuracy | | | | | |
| >>>>TRP High | M | NG-RAN High | The configured | | |
| Accuracy Access | | Accuracy | estimated | | |
| Position | | Access Point | geographical high | | |
| | | Position | accuracy position | | |
| | | 9.2.49 | of the antenna of | | |
| | | | the cell/TRP. | | |
| >Referenced | | | | | |
| >>Reference Point | M | 9.2.51 | The reference | | |
| | | | point is used to | | |
| | | | derive the TRP | | |
| | | | position | | |
| >>CHOICE Type | M | | | | |
| >>>Geodetic | | | | | |
| >>>>TRP Position | M | Relative | The configured | | |
| Relative Geodetic | | Geodetic | estimated relative | | |
| | | Location | geodetic | | |
| | | 9.2.48 | coordinate of the | | |
| | | | antenna of the | | |
| | | | cell/TRP | | |
| >>>Cartesian | | | | | |
| >>>>TRP Position | M | Relative | The configured | | |
| Relative Cartesian | | Cartesian | estimated relative | | |
| | | Location | Cartesian | | |
| | | 9.2.50 | coordinate of the | | |
| | | | antenna of the | | |
| | | | cell/TRP | | |
| DL-PRS Resource | O | 9.2.47 | DL-PRS | — | |
| Coordinates | | | Resource | | |
| | | | Coordinates | | |
| | | | relative to the | | |
| | | | TRP coordinate | | |
| ARP Location | O | 9.2.76 | | Yes | ignore |
| Information | | | | | |
| Mobile Indication | O | ENUMERATED | Indicates | YES | ignore |
| | | (true, . . . ) | whether the TRP | | |
| | | | may move. | | |
| Mobility State | O | ENUMERATED | Indicates | YES | ignore |
| | | (moving, . . . ) | whether the TRP | | |
| | | | is currently | | |
| | | | moving. | | |

In some other example embodiments, the location of the TRP may be determined at the device 130. In this case, the location of the TRP may comprise at least one of an identification of a reference point and a relative location of the TRP with respect to a position of the reference point. For example, the reference point may be associated with a MT co-located with the device 110. The relative location of the TRP with respect to the position of the reference point may be determined as described above. In some example embodiments, the identification of the reference point may comprise an identity (ID) of the reference point. For example, the ID may be a subscription permanent identifier (SUPI) or any other identifier of the MT. As an example, the MT may retrieve the SUPI from its multiple-universal subscriber identity module (USIM) and provide it to the device 110.

In this case, for example, the Reference Point IE may be enhanced to include an ID to uniquely identify the reference point, that is, the MT, as shown in Table 2.

TABLE 2
Reference Point

| | | | | |
|---|---|---|---|---|
| | | | IE Type and | |
| IE/Group Name | Presence | Range | Reference | Semantics Description |

| | | | |
|---|---|---|---|
| CHOICE ReferencePoint | M | | Reference point to |
| | | | which relative location |
| | | | information is related to |
| >Coordinate ID | | | |
| >>Coordinate ID | M | INTEGER(0 . . . 2⁹- | Referential ID mapped |
| | | 1, . . . ) | via OAM |
| >Reference Point | | | |
| Coordinates | | | |
| >>Reference Point | M | NG-RAN Access | |
| Position | | Point Position | |
| | | 9.3.1.174 | |
| >Reference Point | | | |
| Coordinates High | | | |
| Accuracy | | | |
| >>Reference Point High | M | NG-RAN High | |
| Accuracy Access | | Accuracy Access | |
| Position | | Point Position | |
| | | 9.3.1.190 | |
| >Mobile Reference ID | | | |
| >>IAB-MT ID | M | OCTET STRING | An unique ID (e.g. |
| | | | SUPI) to identify the |
| | | | IAB-MT. |

As shown in FIG. 2, the device 110 transmits (220) to the device 120, information indicative of the location of the TRP and/or the corresponding mobility information. Then, the device 120 transmits (225), to the device 130, the information indicative of the location of the TRP and/or the corresponding mobility information.

In the embodiments where the location of the TRP comprises at least one of the identification of the reference point and the relative location of the TRP with respect to the position of the reference point, the device 130 may obtain the position of the reference point. For example, the position of the reference point may be determined using mobile terminal location request (MT-LR) procedure. Then, the device 130 may determine the geo-coordinated position of the TRP based on the position of the reference point and the relative location of the TRP with respect to the position of the reference point. Besides, in this case, the device 130 may save the received mobility information, and use it later. For example, in case there is a further need to use the TRP to position another UE, the device 130 may determine a need to update the position of the reference point, if the saved mobility information which was previously received, indicates that the TRP is mobile. Then, in response to the need to update the location of the reference point, the device 130 may update the position of the reference point, for example, by initiating the MT-LR procedure.

In this way, it is allowed to achieve flexible and accurate UE location determination.

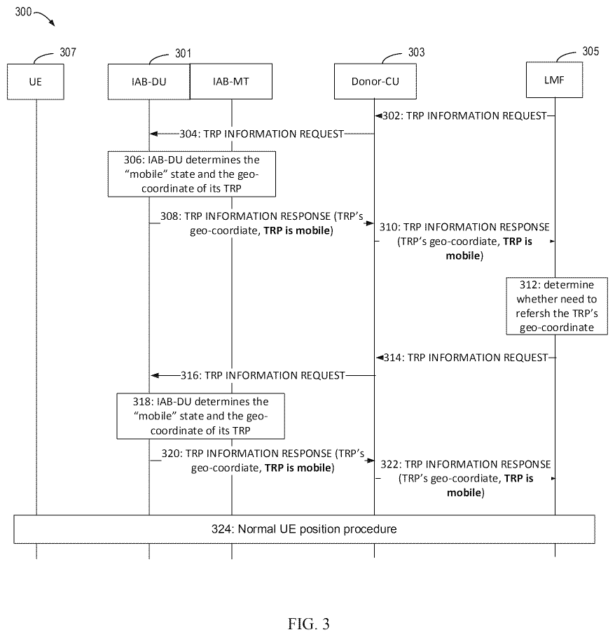

FIG. 3 illustrates an example process 300 for determining UE location according to some example embodiments of the present disclosure. For the purpose of discussion, the process 300 will be described with reference to FIG. 1. In this case, the device 110 is implemented by an IAB-DU 301. The device 120 is implemented by a donor-CU 303. The device 130 is implemented by a LMF 305.

As shown in FIG. 3, at 302, the LMF 305 transmits to the donor-CU 303 the NRPPa: TRP INFORMATION REQUEST message to request information associated with a TRP associated with the IAB-DU 301. Then, at 304, the donor-CU 303 transmits to the IAB-DU 301 the F1AP: TRP INFORMATION REQUEST message to request information associated with the TRP associated with the IAB-DU 301.

At 306, the IAB-DU 301 determines a position of the TRP and corresponding mobility information. For example, the IAB-DU 301 determines the “mobile” states and the geo-coordinate of the TRP. Then, at 308, the IAB-DU 301 transmits to the donor-CU 303 the F1AP: TRP INFORMATION RESPONSE message. For example, the F1AP: TRP INFORMATION RESPONSE message may include information indicative of the geo-coordinate of the TRP and the corresponding mobility information of the TRP, for example, indicating that the TRP is mobile, or indicating that the TRP is mobile during a time period, or indicating that the TRP is not mobile during a time period, or indicating the TRP is mobile during a first time period and not mobile in a second time period. In another example embodiment, the F1AP: TRP INFORMATION RESPONSE message may only include the corresponding mobility information of the TRP, for example, indicating that the TRP is mobile, or indicating that the TRP is mobile during a time period, or indicating that the TRP is not mobile during a time period, or indicating the TRP is mobile during a first time period and not mobile in a second time period. At 310, the donor-CU 303 transmits to the LMF 305 the NRPPa: TRP INFORMATION RESPONSE message. For example, the NRPPa: TRP INFORMATION RESPONSE message may include information indicative of the geo-coordinate of the TRP and the corresponding mobility information of the TRP, for example, indicating that the TRP is mobile, or indicating that the TRP is mobile during a time period, or indicating that the TRP is not mobile during a time period, or indicating the TRP is mobile during a first time period and not mobile in a second time period. In another example embodiment, the NRPPa: TRP INFORMATION RESPONSE message may only include the corresponding mobility information of the TRP, for example, indicating that the TRP is mobile, or indicating that the TRP is mobile during a time period, or indicating that the TRP is not mobile during a time period, or indicating the TRP is mobile during a first time period and not mobile in a second time period.

Later, at 312, the LMF 305 determines whether need to refresh the TPR's geo-coordinate, for example, when there is a need for LMF 305 to position the UE 307 connected with the IAB-DU 301 using the TRP. Since the previous corresponding mobility information of the TRP received in 310 indicates the TRP is “mobile”, the LMF 305 determines a refresh is needed to get the latest location information of the TRP. If the LMF 305 determines a need to refresh the TPR's geo-coordinate, at 314-322, the similar procedure as the procedure of steps 302-310 is repeated. At 322, the LMF 305 determine the latest location information associated with the TRP. And then, at 324, normal UE position procedure using the latest location information of the TRP is performed for the UE 307.

All operations and features as described above with reference to FIGS. 1-2 are likewise applicable to the process 300 and have similar effects. For the purpose of simplification, the details will be omitted.

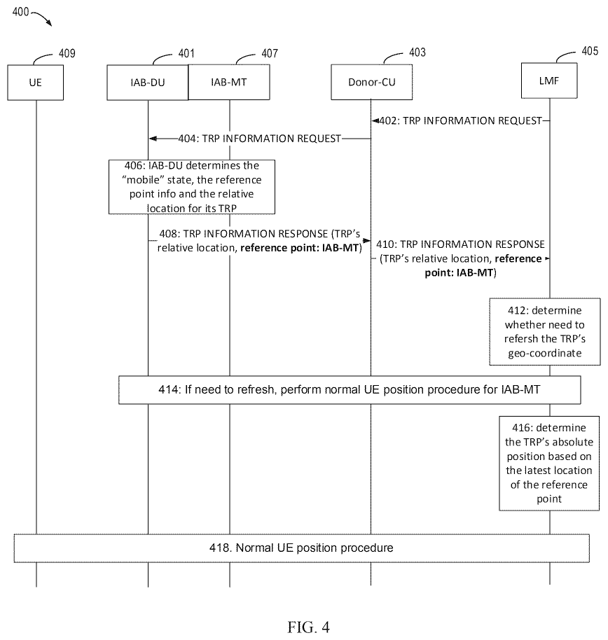

FIG. 4 illustrates an example process 400 for determining UE location according to some other example embodiments of the present disclosure. For the purpose of discussion, the process 400 will be described with reference to FIG. 1. In this case, the device 110 is implemented by an IAB-DU 401. The device 120 is implemented by a donor-CU 403. The device 130 is implemented by a LMF 405.

As shown in FIG. 4, at 402, the LMF 405 transmits to the donor-CU 403 the NRPPa: TRP INFORMATION REQUEST message to request information associated with a TRP associated with the IAB-DU 401. Then, at 404, the donor-CU 403 transmits to the IAB-DU 401 the F1AP: TRP INFORMATION REQUEST message to request information associated with the TRP associated with the IAB-DU 401.

At 406, the IAB-DU 401 determines a position of the TRP and corresponding mobility information. For example, the IAB-DU 401 determines the “mobile” states, the reference point information, that is, an identification of the reference point, and the relative location of the TRP with respect to the position of the reference point. In this case, for example, the reference point may be the IAB-MT 407. Then, at 408, the IAB-DU 401 transmits to the donor-CU 403 the F1AP: TRP INFORMATION RESPONSE message. For example, the F1AP: TRP INFORMATION RESPONSE message may include information indicative of the reference point information and the relative location of the TRP with respect to the position of the reference point and the corresponding mobility information of the TRP, for example, indicating that the TRP is mobile, or indicating that the TRP is mobile during a time period, or indicating that the TRP is not mobile during a time period, or indicating the TRP is mobile during a first time period and not mobile in a second time period. At 410, the donor-CU 403 transmits to the LMF 405 the NRPPa: TRP INFORMATION RESPONSE message. For example, the NRPPa: TRP INFORMATION RESPONSE message may include information indicative of the reference point information and the relative location of the TRP with respect to the position of the reference point and the corresponding mobility information of the TRP, for example, indicating that the TRP is mobile, or indicating that the TRP is mobile during a time period, or indicating that the TRP is not mobile during a time period, or indicating the TRP is mobile during a first time period and not mobile in a second time period.

Later, at 412, the LMF 405 determines whether need to refresh the TPR's geo-coordinate, for example, when there is a need for LMF to position the UE 409 connected with the IAB-DU 401 using the TRP. Since the previous corresponding mobility information of the TRP received in 410 indicates the TRP is “mobile”, the LMF 405 determines a refresh is needed to get the latest location information of the TRP. At 414, if the LMF 405 determines a need to refresh the TPR's geo-coordinate, for example, the normal UE position procedure for the reference point is performed. Further, at 416, the LMF 405 determines the TRP's latest absolute position based on the updated position of the reference point and the relative location of the TRP with respect to the position of the reference point. Then, at 418, normal UE position procedure using the latest location information of the TRP is performed for the UE 409.

All operations and features as described above with reference to FIGS. 1-2 are likewise applicable to the process 400 and have similar effects. For the purpose of simplification, the details will be omitted.

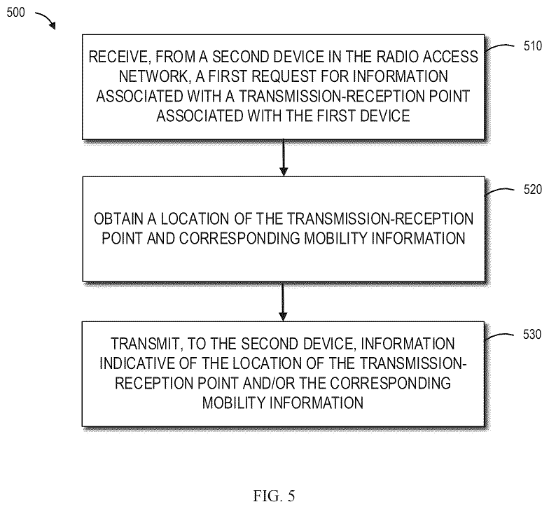

FIG. 5 illustrates a flowchart of an example method according to some example embodiments of the present disclosure. The method 500 can be implemented at the device 110 as shown in FIG. 1. For the purpose of discussion, the method 500 will be described with reference to FIG. 1.

At block 510, the device 110 receives, from the device 120 in the radio access network 125, a first request for information associated with a transmission-reception point associated with the device 110. At block 520, the device 110 obtains a location of the transmission-reception point and corresponding mobility information. At block 530, the device 110 transmits, to the device 120, information indicative of the location of the transmission-reception point and/or the corresponding mobility information.

In some example embodiments, the corresponding mobility information may indicate that the transmission-reception point is mobile.

In some example embodiments, the corresponding mobility information may indicate whether the transmission-reception point is mobile or not mobile during a time period.

In some example embodiments, the location of the transmission-reception point may comprise a geo-coordinated position of the transmission-reception point.

In some example embodiments, the device 110 may obtain a position of a reference point; and determine the geo-coordinated position of the transmission-reception point based on a position of a reference point.

In some example embodiments, the location of the transmission-reception point may comprise at least one of an identification of a reference point and a relative location of the transmission-reception point with respect to a position of the reference point.

In some example embodiments, the identification of the reference point may comprise an identity of the reference point.

In some example embodiments, the reference point may be associated with a mobile terminal device co-located with the device 110.

In some example embodiments, the device 110 may be a distributed unit of an integrated access and backhaul device, and the device 120 may be a centralized unit of a donor device.

Those skilled in the art can understand that all operations and features as described above with reference to FIGS. 1-4 are likewise applicable to the method 500 and have similar effects.

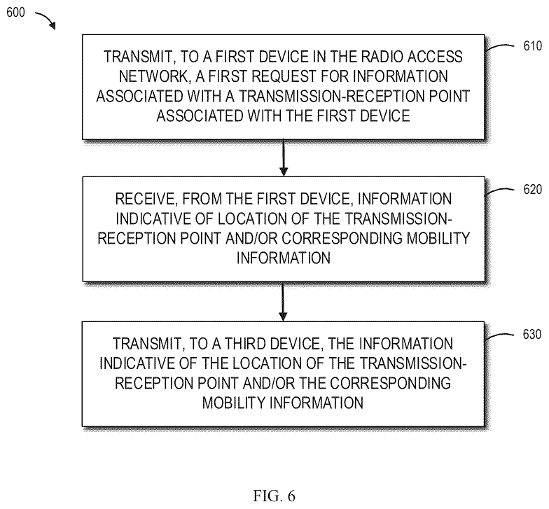

FIG. 6 illustrates a flowchart of an example method 600 according to some other example embodiments of the present disclosure. The method 600 can be implemented at the device 120 as shown in FIG. 1. For the purpose of discussion, the method 600 will be described with reference to FIG. 1.

At block 610, the device 120 transmits, to the device 110 in the radio access network 125, a first request for information associated with a transmission-reception point associated with the first device. At block 620, the device 120 receives, from the device 110, information indicative of location of the transmission-reception point and/or corresponding mobility information. At block 630, the device 120 transmits, to the device 130, the information indicative of the location of the transmission-reception point and/or the corresponding mobility information.

In some example embodiments, the corresponding mobility information may indicate that the transmission-reception point is mobile.

In some example embodiments, the corresponding mobility information may indicate whether the transmission-reception point is mobile or not mobile during a time period.

In some example embodiments, the device 120 may, in response to receiving, from the third device, a second request for the information associated with the transmission-reception point, transmit to the first device, the first request for the information associated with the transmission-reception point.

In some example embodiments, the location of the transmission-reception point may comprise a geo-coordinated position of the transmission-reception point.

In some example embodiments, the location of the transmission-reception point may comprise at least one of an identification of a reference point and a relative location of the transmission-reception point with respect to a position of the reference point.

In some example embodiments, the identification of the reference point may comprise an identity of the reference point.

In some example embodiments, the reference point may be associated with a mobile terminal device co-located with the device 110.

In some example embodiments, the device 110 may be a distributed unit of an integrated access and backhaul device, and the device 120 may be a centralized unit of a donor device, and the device 130 may be a location management function.

Those skilled in the art can understand that all operations and features as described above with reference to FIGS. 1-5 are likewise applicable to the method 600 and have similar effects.

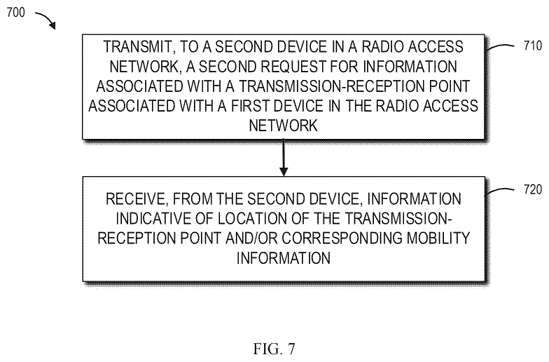

FIG. 7 illustrates a flowchart of an example method 700 according to some further example embodiments of the present disclosure. The method 700 can be implemented at the device 130 as shown in FIG. 1. For the purpose of discussion, the method 700 will be described with reference to FIG. 1.

At block 710, the device 130 transmits, to the device 120 in a radio access network 128, a second request for information associated with a transmission-reception point associated with the device 110 in the radio access network 125. At block 720, the device 130 receives, from the device 120, information indicative of location of the transmission-reception point and/or corresponding mobility information.

In some example embodiments, the corresponding mobility information may indicate that the transmission-reception point is mobile.

In some example embodiments, the corresponding mobility information may indicate whether the transmission-reception point is mobile or not mobile during a time period.

In some example embodiments, the location of the transmission-reception point may comprise a geo-coordinated position of the transmission-reception point.

In some example embodiments, the device 130 may, in response to the corresponding mobility information indicating that the transmission-reception point is mobile, determine a need to update the location of the transmission-reception point; and in response to the need to update the location of the transmission-reception point, transmit, to the second device, the second request for the information associated with the transmission-reception point.

In some example embodiments, the location of the transmission-reception point may comprise at least one of an identification of a reference point and a relative location of the transmission-reception point with respect to a position of the reference point.

In some example embodiments, the device 130 may obtain the position of the reference point; and determine a geo-coordinated position of the transmission-reception point based on the position of the reference point and the relative location of the transmission-reception point with respect to the position of the reference point.

In some example embodiments, the device 130 may in response to the corresponding mobility information indicating that the transmission-reception point is mobile, determine a need to update the position of the reference point; and in response to the need to update the position of the reference point, determine the position of the reference point.

In some example embodiments, the identification of the reference point may comprise an identity of the reference point.

In some example embodiments, the reference point may be associated with a mobile terminal device co-located with the device 110.

In some example embodiments, the device 110 may be a distributed unit of an integrated access and backhaul device, and the device 120 may be a centralized unit of a donor device, and the device 130 may be a location management function.

Those skilled in the art can understand that all operations and features as described above with reference to FIGS. 1-6 are likewise applicable to the method 700 and have similar effects.

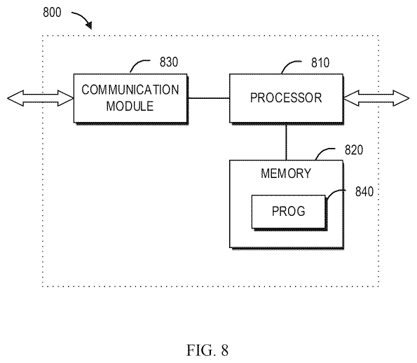

FIG. 8 is a simplified block diagram of a device 800 that is suitable for implementing example embodiments of the present disclosure. The device 800 can be implemented at or as a part of the device 110, or the device 120, or the device 130 as shown in FIG. 1.

As shown, the device 800 includes a processor 810, a memory 820 coupled to the processor 810, a communication module 830 coupled to the processor 810, and a communication interface (not shown) coupled to the communication module 830. The memory 820 stores at least a program 840. The communication module 830 is for bidirectional communications, for example, via multiple antennas. The communication interface may represent any interface that is necessary for communication.

The program 840 is assumed to include program instructions that, when executed by the associated processor 810, enable the device 800 to operate in accordance with the example embodiments of the present disclosure, as discussed herein with reference to FIGS. 1-7. The example embodiments herein may be implemented by computer software executable by the processor 810 of the device 800, or by hardware, or by a combination of software and hardware. The processor 810 may be configured to implement various example embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

When the device 800 acts as the device 110 or a part of the device 110, the processor 810 and the communication module 830 may cooperate to implement the method 500 as described above with reference to FIG. 5. When the device 800 acts as the device 120 or a part of the device 120, the processor 810 and the communication module 830 may cooperate to implement the method 600 as described above with reference to FIG. 6. When the device 800 acts as the device 130 or a part of the device 130, the processor 810 and the communication module 830 may cooperate to implement the method 700 as described above with reference to FIG. 7. All operations and features as described above with reference to FIGS. 1-7 are likewise applicable to the device 800 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 or 700 as described above with reference to FIGS. 5-7. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first device in a radio access network, receiving, from a second device in the radio access network, a first request for information associated with a transmission-reception point associated with the first device; obtaining a location of the transmission-reception point and corresponding mobility information; and transmitting, to the second device, information indicative of the location of the transmission-reception point and/or the corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, the location of the transmission-reception point comprises a geo-coordinated position of the transmission-reception point.

In some example embodiments, the method further comprises: obtaining a position of a reference point; and determining the geo-coordinated position of the transmission-reception point based on a position of a reference point.

In some example embodiments, the location of the transmission-reception point comprises at least one of an identification of a reference point and a relative location of the transmission-reception point with respect to a position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device.

In some aspects, a method comprises: at a second device in a radio access network, transmitting, to a first device in the radio access network, a first request for information associated with a transmission-reception point associated with the first device; receiving, from the first device, information indicative of location of the transmission-reception point and/or corresponding mobility information; and transmitting, to a third device, the information indicative of the location of the transmission-reception point and/or the corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, transmitting the first request for the information associated with the transmission-reception point associated with the first device comprises: in response to receiving, from the third device, a second request for the information associated with the transmission-reception point, transmitting, to the first device, the first request for the information associated with the transmission-reception point.

In some example embodiments, the location of the transmission-reception point comprises a geo-coordinated position of the transmission-reception point.

In some example embodiments, the location of the transmission-reception point comprises at least one of an identification of a reference point and a relative location of the transmission-reception point with respect to a position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device, and the third device is a location management function.

In some aspects, a method comprises: at a third device, transmitting, to a second device in a radio access network, a second request for information associated with a transmission-reception point associated with a first device in the radio access network; and receiving, from the second device, information indicative of location of the transmission-reception point and/or corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, wherein the location of the transmission-reception point comprises a geo-coordinated position of the transmission-reception point.

In some example embodiments, the method further comprises: in response to the corresponding mobility information indicating that the transmission-reception point is mobile, determining a need to update the location of the transmission-reception point; and in response to the need to update the location of the transmission-reception point, transmitting, to the second device, the second request for the information associated with the transmission-reception point.

In some example embodiments, the location of the transmission-reception point comprises at least one of an identification of a reference point and a relative location of the transmission-reception point with respect to a position of the reference point.

In some example embodiments, the method further comprises: obtaining the position of the reference point; and determining a geo-coordinated position of the transmission-reception point based on the position of the reference point and the relative location of the transmission-reception point with respect to the position of the reference point.

In some example embodiments, the method further comprises: in response to the corresponding mobility information indicating that the transmission-reception point is mobile, determining a need to update the position of the reference point; and in response to the need to update the position of the reference point, determining the position of the reference point. In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device, and the third device is a location management function.

In some aspects, a first device, comprises: at least one processor; and at least one memory including computer program code; the at least one memory and the computer program code configured to, with the at least one processor, cause the first device to: receive, from a second device in the radio access network, a first request for information associated with a transmission-reception point associated with the first device; obtain a location of the transmission-reception point and corresponding mobility information; and transmit, to the second device, information indicative of the location of the transmission-reception point and/or the corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, the location of the transmission-reception point comprises a geo-coordinated position of the transmission-reception point.

In some example embodiments, the first device is further caused to: obtain a position of a reference point; and determine the geo-coordinated position of the transmission-reception point based on a position of a reference point.

In some example embodiments, the location of the transmission-reception point comprises at least one of an identification of a reference point and a relative location of the transmission-reception point with respect to a position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device.

In some aspects, a second device, comprises: at least one processor; and at least one memory including computer program code; the at least one memory and the computer program code configured to, with the at least one processor, cause the second device to: transmit, to a first device in the radio access network, a first request for information associated with a transmission-reception point associated with the first device; receive, from the first device, information indicative of location of the transmission-reception point and/or corresponding mobility information; and transmit, to a third device, the information indicative of the location of the transmission-reception point and/or the corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, the second device is caused to transmit the first request for the information associated with the transmission-reception point associated with the first device by: in response to receiving, from the third device, a second request for the information associated with the transmission-reception point, transmitting, to the first device, the first request for the information associated with the transmission-reception point.

In some example embodiments, the location of the transmission-reception point comprises a geo-coordinated position of the transmission-reception point.

In some example embodiments, the location of the transmission-reception point comprises at least one of an identification of a reference point and a relative location of the transmission-reception point with respect to a position of the reference point.

In some example embodiments, the identification of the reference point comprises an identity of the reference point.

In some example embodiments, the reference point is associated with a mobile terminal device co-located with the first device.

In some example embodiments, wherein the first device is a distributed unit of an integrated access and backhaul device, and the second device is a centralized unit of a donor device, and the third device is a location management function.

In some aspects, a third device, comprises: at least one processor; and at least one memory including computer program code; the at least one memory and the computer program code configured to, with the at least one processor, cause the third device to: transmit, to a second device in a radio access network, a second request for information associated with a transmission-reception point associated with a first device in the radio access network; and receive from the second device, information indicative of location of the transmission-reception point and/or corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, the location of the transmission-reception point comprises a geo-coordinated position of the transmission-reception point.

In some example embodiments, the third device is further caused to: in response to the corresponding mobility information indicating that the transmission-reception point is mobile, determine a need to update the location of the transmission-reception point; and in response to the need to update the location of the transmission-reception point, transmit, to the second device, the second request for the information associated with the transmission-reception point.

In some example embodiments, the location of the transmission-reception point comprises at least one of an identification of a reference point and a relative location of the transmission-reception point with respect to a position of the reference point.

In some example embodiments, the third device is further caused to: obtain the position of the reference point; and determine a geo-coordinated position of the transmission-reception point based on the position of the reference point and the relative location of the transmission-reception point with respect to the position of the reference point.

In some example embodiments, the third device is further caused to: in response to the corresponding mobility information indicating that the transmission-reception point is mobile, determine a need to update the position of the reference point; and in response to the need to update the position of the reference point, determine the position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device, and the third device is a location management function.

In some aspects, an apparatus comprises: means for receiving, from a second device in the radio access network, a first request for information associated with a transmission-reception point associated with a first device; means for obtaining a location of the transmission-reception point and corresponding mobility information; and means for transmitting, to the second device, information indicative of the location of the transmission-reception point and/or the corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, the location of the transmission-reception point comprises a geo-coordinated position of the transmission-reception point.

In some example embodiments, the apparatus further comprises: means for obtaining a position of a reference point; and determining the geo-coordinated position of the transmission-reception point based on a position of a reference point.

In some example embodiments, the location of the transmission-reception point comprises at least one of an identification of a reference point and a relative location of the transmission-reception point with respect to a position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device.

In some aspects, an apparatus comprises: means for transmitting, to a first device in the radio access network, a first request for information associated with a transmission-reception point associated with the first device; means for receiving, from the first device, information indicative of location of the transmission-reception point and/or corresponding mobility information; and means for transmitting, to a third device, the information indicative of the location of the transmission-reception point and/or the corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, the means for transmitting the first request for the information associated with the transmission-reception point associated with the first device comprises: means for in response to receiving, from the third device, a second request for the information associated with the transmission-reception point, transmitting, to the first device, the first request for the information associated with the transmission-reception point.

In some example embodiments, the location of the transmission-reception point comprises a geo-coordinated position of the transmission-reception point.

In some example embodiments, the location of the transmission-reception point comprises at least one of an identification of a reference point and a relative location of the transmission-reception point with respect to a position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device, and the third device is a location management function.

In some aspects, an apparatus comprises: means for transmitting, to a second device in a radio access network, a second request for information associated with a transmission-reception point associated with a first device in the radio access network; and means for receiving, from the second device, information indicative of location of the transmission-reception point and/or corresponding mobility information.

In some example embodiments, the corresponding mobility information indicates that the transmission-reception point is mobile.

In some example embodiments, the corresponding mobility information indicates whether the transmission-reception point is mobile or not mobile during a time period.

In some example embodiments, wherein the location of the transmission-reception point comprises a geo-coordinated position of the transmission-reception point.

In some example embodiments, the apparatus further comprises: means for in response to the corresponding mobility information indicating that the transmission-reception point is mobile, determining a need to update the location of the transmission-reception point; and means for in response to the need to update the location of the transmission-reception point, transmitting, to the second device, the second request for the information associated with the transmission-reception point.

In some example embodiments, the location of the transmission-reception point comprises at least one of an identification of a reference point and a relative location of the transmission-reception point with respect to a position of the reference point.

In some example embodiments, the apparatus further comprises: means for obtaining the position of the reference point; and means for determining a geo-coordinated position of the transmission-reception point based on the position of the reference point and the relative location of the transmission-reception point with respect to the position of the reference point.

In some example embodiments, the apparatus further comprises: means for in response to the corresponding mobility information indicating that the transmission-reception point is mobile, determining a need to update the position of the reference point; and means for in response to the need to update the position of the reference point, determining the position of the reference point.

In some example embodiments, the identification of the reference point comprises an identity of the reference point.

In some example embodiments, the reference point is associated with a mobile terminal device co-located with the first device.

In some example embodiments, the first device is a distributed unit of an integrated access and backhaul device, and the second device is a centralized unit of a donor device, and the third device is a location management function.

In some aspects, a computer readable storage medium comprises program instructions stored thereon, the instructions, when executed by a processor of a device, causing the device to perform the method according to some example embodiments of the present disclosure.

1-29. (canceled)

30. A first device, comprising:
at least one processor; and
at least one memory including instructions which, when executed by the at least one processor, cause the first device to:
receive, from a second device in a radio access network, a first request for information associated with a transmission-reception point associated with the first device;
obtain a location of the transmission-reception point and corresponding mobility information; and
transmit, to the second device, information indicative of at least one of the location of the transmission-reception point or the corresponding mobility information.

31. The first device of claim 30, wherein the corresponding mobility information indicates that the transmission-reception point is mobile.

32. (canceled)

33. The first device of claim 30, wherein the location of the transmission-reception point comprises a geo-coordinated position of the transmission-reception point.

34. The first device of claim 33, wherein the first device is further caused to:
obtain a position of a reference point; and
determine the geo-coordinated position of the transmission-reception point based on a position of a reference point.

35. (canceled)

36. (canceled)

37. The first device of claim 34, wherein the reference point is associated with a mobile terminal device co-located with the first device.

38. (canceled)

39. A second device, comprising:
at least one processor; and
at least one memory including instructions which, when executed by the at least one processor, cause the second device to:
transmit, to a first device in a radio access network, a first request for information associated with a transmission-reception point associated with the first device;
receive, from the first device, information indicative of at least one of a location of the transmission-reception point or corresponding mobility information; and
transmit, to a third device, the information indicative of at least one of the location of the transmission-reception point or the corresponding mobility information.

40. The second device of claim 39, wherein the corresponding mobility information indicates that the transmission-reception point is mobile.

41. The second device of claim 39, wherein the corresponding mobility information indicates whether the transmission-reception point is mobile or not mobile during a time period.

42. The second device of claim 39, wherein the second device is caused to transmit the first request for the information associated with the transmission-reception point associated with the first device by:
in response to receiving, from the third device, a second request for the information associated with the transmission-reception point, transmitting, to the first device, the first request for the information associated with the transmission-reception point.

43. (canceled)

44. The second device of claim 39, wherein the location of the transmission-reception point comprises at least one of an identification of a reference point and a relative location of the transmission-reception point with respect to a position of the reference point.

45. (canceled)

46. The second device of claim 44, wherein the reference point is associated with a mobile terminal device co-located with the first device.

47. The second device of claim 39, wherein the first device is a distributed unit of an integrated access and backhaul device, and the second device is a centralized unit of a donor device, and the third device is a location management function.

48. A third device, comprising:
at least one processor; and
at least one memory including instructions which, when executed by the at least one processor, cause the third device to:
transmit, to a second device in a radio access network, a second request for information associated with a transmission-reception point associated with a first device in the radio access network; and
receive from the second device, information indicative of at least one of a location of the transmission-reception point or corresponding mobility information.

49. The third device of claim 48, wherein the corresponding mobility information indicates that the transmission-reception point is mobile.

50. The third device of claim 48, wherein the corresponding mobility information indicates whether the transmission-reception point is mobile or not mobile during a time period.

51. The third device of claim 48, wherein the location of the transmission-reception point comprises a geo-coordinated position of the transmission-reception point.

52. The third device of claim 51, wherein the third device is further caused to:
in response to the corresponding mobility information indicating that the transmission-reception point is mobile, determine a need to update the location of the transmission-reception point; and
in response to the need to update the location of the transmission-reception point, transmit, to the second device, the second request for the information associated with the transmission-reception point.

53. The third device of claim 48, wherein the location of the transmission-reception point comprises at least one of an identification of a reference point and a relative location of the transmission-reception point with respect to a position of the reference point.

54. (canceled)

55. The third device of claim 53, wherein the third device is further caused to:
in response to the corresponding mobility information indicating that the transmission-reception point is mobile, determine a need to update the position of the reference point; and
in response to the need to update the position of the reference point, determine the position of the reference point.

56. The third device of claim 48, wherein the identification of the reference point comprises an identity of the reference point.

57. (canceled)

58. The third device of claim 48, wherein the first device is a distributed unit of an integrated access and backhaul device, and the second device is a centralized unit of a donor device, and the third device is a location management function.

59-64. (canceled)
